(19) United States
(12) Patent Application Publication
(10) Pub. No.: US 2004/0003381 A1
(43) Pub. Date: Jan. 1, 2004

(54) Compiler program and compilation processing method

(75) Inventors: Kiyofumi Suzuki, Kawasaki (JP); Masaki Aoki, Kawasaki (JP); Hiroaki Sato, Shinagawa (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/465,710

(22) Filed: Jun. 19, 2003

(30) Foreign Application Priority Data
Jun. 28, 2002 (JP) 2002-190052

(51) Int. Cl. G06F 9/45

(52) U.S. Cl. 717/150; 717/160

(57) ABSTRACT

In a compiler, a source program analysis unit forms an intermediate program by analyzing a source program. A vectorization unit extracts logically vectorizable loops from the intermediate program, gives a SIMD expression to each loop regardless of whether or not the corresponding SIMD instruction exists, and vectorizes all the loops. A vector operation expansion unit performs unrolling expansion of a portion with no corresponding SIMD instruction, selection of an optimum vector length, etc. An instruction scheduling unit optimizes the intermediate program, and assign instructions. A code generation unit forms an object program from the intermediate program.

### BACKGROUND OF THE INVENTION

1. Field of the Invention

This invention generally relates to a compiler program and a compiler processing method, and more particularly to a technique for improving the performance of a loop portion of a source program when the loop portion is executed in translation of the program, and to a program compilation technique using vectorization processing.

2. Description of the Related Art

In the field of technological calculation with computers, the execution performance of a program is the most important criterion for evaluation of hardware and software (compiler). It is known that a program in the field of technological calculation has a high execution cost with respect to its loop portion.

As hardware designed to increase the speed of a loop portion of a program, a computer having a SIMD (Single Instruction stream Multiple Data stream) mechanism is known. A SIMD mechanism is an arithmetic architecture or component in which parallel executions of one instruction are carried out on groups of data respectively supplied to a plurality of arithmetic units. A SIMD mechanism is also referred to as a vector operation mechanism, and the instruction executed by the SIMD mechanism is referred to as a SIMD instruction or a vector instruction.

As hardware equipped with a SIMD mechanism, the vector supercomputer VPP series (FUJITSU LIMITED) and the SX series (NEC Corporation) are known. Pentium 3/Pentium 4 chip (Intel Corporation in U.S.) also has a SIMD mechanism named SSE/SSE2. Further, small incorporated-type CPU chips having a SIMD mechanism suitable for high-speed operation have been developed.

A compiler for such SIMD mechanisms generates a SIMD instruction by an automatic vectorization function. Ordinarily, such an automatic vectorization function generates a SIMD instruction with respect to a loop structure in a program. However, if a computation which cannot be expressed by a SIMD instruction provided in CPUs to operate appears in a loop of a program, it cannot be directly vectorized.

Conventionally, if a computation which cannot be vectorized appears in a loop of a program, the entire loop is treated as a nonvectorizable portion or the loop is divided into a vectorizable portion and a nonvectorizable portion. Dividing a loop into a vectorizable portion and a nonvectorizable portion is referred to as partial vectorization.

FIG. 13 is a diagram showing an example of partial vectorization in the conventional art. In FIG. 13, for ease of understanding, a program is shown as a source image. A symbol for a sequence with no suffix is assumed to represent all sequence elements (the same applies in the entire specification and with respect to all the drawings).

In FIG. 13A, an example of a program before partial vectorization is shown. In the computation of first-time sequence element A(I) in the program shown in FIG. 13A, the sum of B(I) and C(I) is obtained. In the computation of second-time sequence element A(I), the product of B(I) and C(I) is obtained. The result of each computation is output by a print statement. That is, the computation of first-time sequence element A(I) is performed as processing (1); outputting of first-time sequence element A(I) by the print statement is performed as processing (2); the computation of second-time sequence element A(I) is performed as processing (3); processings (1) to (3) are repeated by a Do loop from I=1 to I=100; and all the results of the computations of second-time sequence element A are output at a time by processing (4). In vectorization of the loop portion of this program, the entire loop portion cannot be simply vectorized since the print statement in the loop is a nonvectorizable portion.

In the method of partial vectorization in the conventional compiler, therefore, vectorizable portions and nonvectorizable portions in the loop portion of the program shown in FIG. 13A are separated from each other to be expanded into a program such as shown in FIG. 13B, which is an example of a program formed by partial vectorization of the program shown in FIG. 13A.

In the program shown in FIG. 13B, the print statement (processing (2)), which is a nonvectorizable portion in the loop portions (processings (1) to (3)) of the program shown in FIG. 13A, is taken out of the loop and separated into processing (1)′ which is a vectorizable portion, processing (2)′ which is a nonvectorizable portion, and processing (3)′ which is a vectorizable portion. With respect to the definition of second-time sequence element A(I), the result is stored in a temporary work area (Temp) by processing (1)′ and data is delivered from the sequence Temp to sequence A by processing (3)′. In the process shown in FIG. 13B, processing (1)′ and processing (3)′ are vectorizable portions, while processing (2)′ and processing (4)′ (processing (4) shown in FIG. 13A) are nonvectorizable portions.

In the above-described conventional partial vectorization, vectorizable portions and nonvectorizable portions are separated from each other and there is a possibility of data exchange therebetween requiring a temporary work area (see the above-described conventional art) and influencing the execution time.

Compilation of a program executed by hardware equipped with no SIMD mechanism is performed without vectorization of the program and is, therefore, incapable of concealment of operational latency and reduction in indirect overhead with respect to time due to repeated execution of a loop. Operational latency is a (concealed) wait time between arithmetical instructions.

### SUMMARY OF THE INVENTION

In view of the above-described problems, an object of the present invention is to provide, in a compiler which compiles a program executed on hardware equipped with a SIMD mechanism or not equipped with any SIMD mechanism, a compiler program and recording medium thereof in which the execution speed of a loop portion, in particular, of the program can be increased by vectorization of the program.

Another object of the present invention is to provide a compilation processing method and apparatus which improves the execution performance of a loop portion, in particular, of a program by vectorization of the program in compilation processing on a program executed on hardware equipped with a SIMD mechanism or not equipped with any SIMD mechanism.

A compiler program of the present invention is a compiler program for compiling a program executed on a computer equipped with a SIMD mechanism, and includes the program which causes the computer executing inputting and analyzing a source program; providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program; expanding the computation portion of the vectorizable loop expressed by the pseudo-SIMD instruction expression by replacing the computation portion with sequential instructions in the loop; and generating an object program on a basis of the result of the expanding.

Further, a compiler program of the present invention is a compiler program for compiling a program executed on a computer equipped with no SIMD mechanism, and includes the program which causes the computer executing: inputting and analyzing a source program; providing a pseudo-SIMD instruction expression for a computation in a loop of the source program to make the loop vectorizable with reference to the result of analysis of the source program by assuming that the computer has a SIMD mechanism; expanding the computation portion of the vectorizable loop expressed by the pseudo-SIMD instruction expression by replacing the computation portion with sequential instructions in the loop; and generating an object program on a basis of the result of the expanding.

A recording medium for a compiler program of the present invention is a recording medium for recording a compiler program to compile a program executed on a computer equipped with a SIMD mechanism, and records the program to cause the computer executing: inputting and analyzing a source program; providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program; expanding the computation portion of the vectorizable loop expressed by the pseudo-SIMD instruction expression by replacing the computation portion with sequential instructions in the loop; and generating an object program on a basis of the result of the expanding.

Further, a recording medium for a compiler program of the present invention is a recording medium for recording a compiler program to compile a program executed on a computer equipped with no SIMD mechanism, and records the program to cause the computer executing: inputting and analyzing a source program; providing a pseudo-SIMD instruction expression for a computation in a loop of the source program to make the loop vectorizable with reference to the result of analysis of the source program by assuming that the computer has a SIMD mechanism; expanding the computation portion of the vectorizable loop expressed by the pseudo-SIMD instruction expression by replacing the computation portion with sequential instructions in the loop; and generating an object program on a basis of the result of the expanding.

A compilation processing method of the present invention is a compilation processing method for compiling a program executed on a computer equipped with a SIMD mechanism, and comprises: inputting and analyzing a source program; providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program; expanding the computation portion of the vectorizable loop expressed by the pseudo-SIMD instruction expression by replacing the computation portion with sequential instructions in the loop; and generating an object program on a basis of the result of the expanding.

Further, a compilation processing method of the present invention is a compilation processing method for compiling a program executed on a computer equipped with no SIMD mechanism, and comprises: inputting and analyzing a source program; providing a pseudo-SIMD instruction expression for a computation in a loop of the source program to make the loop vectorizable with reference to the result of analysis of the source program by assuming that the computer has a SIMD mechanism; expanding the computation portion of the vectorizable loop expressed by the pseudo-SIMD instruction expression by replacing the computation portion with sequential instructions in the loop; and generating an object program on a basis of the result of the expanding.

A compilation processing apparatus of the present invention is a compilation processing apparatus for compiling a program executed on a computer equipped with a SIMD mechanism, and comprises: means for inputting and analyzing a source program; means for providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program; means for expanding the computation portion of the vectorizable loop expressed by the pseudo-SIMD instruction expression by replacing the computation portion with sequential instructions in the loop; and means for generating an object program on a basis of the result of the expanding.

Further, a compilation processing apparatus of the present invention is a compilation processing apparatus for compiling a program executed on a computer equipped with no SIMD mechanism, and comprises: means for inputting and analyzing a source program; means for providing a pseudo-SIMD instruction expression for a computation in a loop of the source program to make the loop vectorizable with reference to the result of analysis of the source program by assuming that the computer has a SIMD mechanism; means for expanding the computation portion of the vectorizable loop expressed by the pseudo-SIMD instruction expression by replacing the computation portion with sequential instructions in the loop; and means for generating an object program on a basis of the result of the expanding.

The present invention has a feature that, to achieve the above-described objects, a loop including an operation nonvectorizable in the conventional art or nonvectorizable computation processed by partial vectorization is assumed to be a vectorizable loop by using a pseudo-vector operation expression, and is thereafter compiled.

This processing ensures that, on hardware equipped with a SIMD mechanism, the entire loop is made vectorizable to enable effective use of the entire SIMD mechanism and to remarkably improve the execution performance, and that, on hardware equipped with no SIMD mechanism, concealment of operational latency and a reduction in indirect time overhead due to repeated execution of the loop can be achieved and improve the execution performance.

### BRIEF DESCRIPTION OF THE DRAWINGS

FIG. 1 is a diagram showing the configuration of a system in accordance with the present invention.

FIG. 2 is a flowchart of vectorization processing in Embodiment 1.

FIG. 3 is a flowchart of vector operation expansion processing in Embodiment 1.

FIGS. 4A, 4B, and 4C are diagrams for explaining, by comparison, the difference between conventional partial vectorization and vectorization in Embodiment 1.

FIG. 5 is a flowchart of vector operation expansion processing in Embodiment 2.

FIGS. 6A to 6E are diagrams for explaining, by comparison, the difference between conventional unrolling expansion and unrolling expansion in Embodiment 2.

FIGS. 7A and 7B are diagrams for explaining vectorization in Embodiment 3.

FIGS. 8A, 8B, and 8C are diagrams showing an example of an intermediate language image of vector operation expansion in Example 1.

FIGS. 9A, 9B, and 9C are diagrams showing an example of an intermediate language image of vector operation expansion in Example 2.

FIGS. 10A and 10B are diagrams showing an example of an intermediate language image after vectorization processing in Example 3.

FIG. 11 is a diagram showing an example of an intermediate language image of vector operation expansion in Example 3.

FIGS. 12A, 12B, and 12C are diagrams showing an example of an intermediate language image of vector operation expansion in Example 4.

FIGS. 13A and 13B are a diagram showing an example of partial vectorization in conventional art.

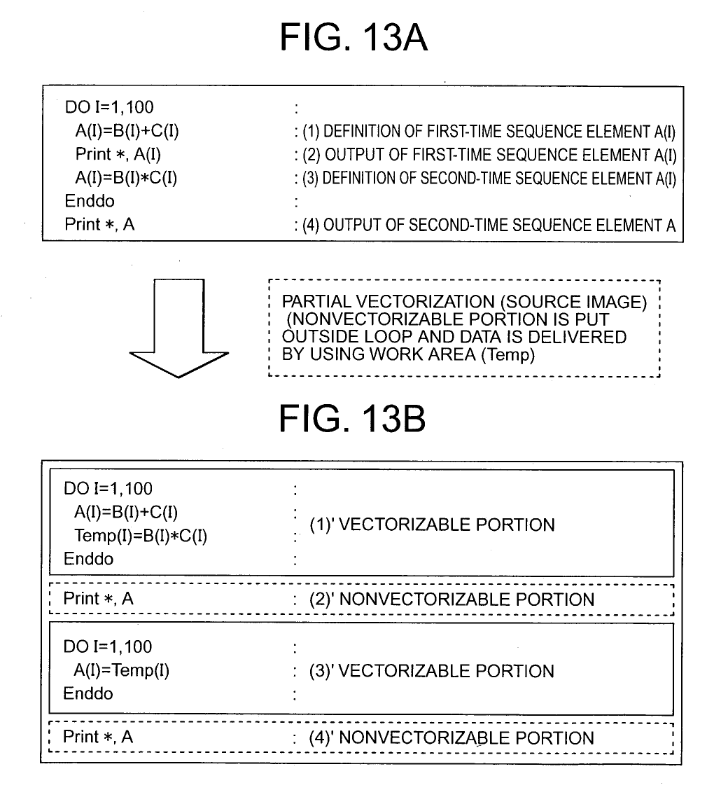

### DETAILED DESCRIPTION OF THE PREFERRED EMBODIMENTS

Embodiments of the present invention will be described with reference to the drawings.

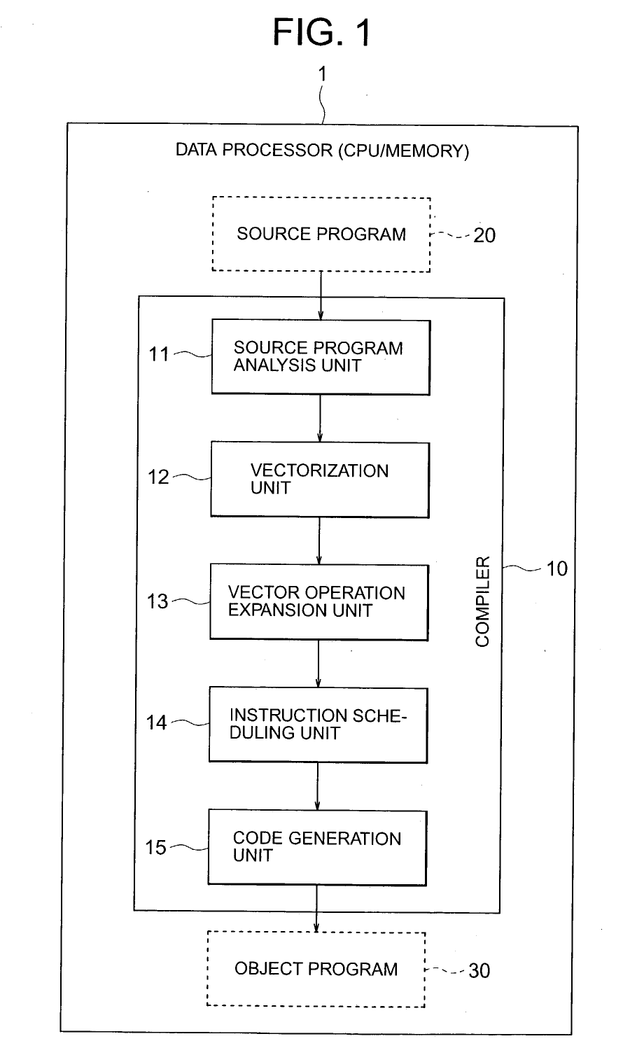

FIG. 1 is a diagram showing the configuration of a system in an embodiment of the present invention. A data processor 1 is a computer constituted by a CPU (central processing unit) and a memory. A compiler 10 is a program for translating (compiling) a source program 20 written in a high-level language into an object program 30 formed of a sequence of machine language instructions. The compiler 10 is installed in the computer to function as a source program analysis portion 11, a vectorization unit 12, a vector operation expansion unit 13, an instruction scheduling unit 14, and a code generation unit 15. This software program can be supplied through a medium such as a CD-ROM (compact disc read only memory), a MO (magneto-optical disk) or a DVD (digital video disk), or through a network.

The source program analysis unit 11 analyzes the source program 20 and forms an intermediate program (a text written in an intermediate language). The vectorization unit 12 receives the intermediate program from the source program analysis unit 11, extracts loop as a vectorizable portion from the program, and executes vectorization processing. This processing can be performed even if the extracted loop includes a computation without a SIMD instruction corresponding to the computer on which the object program 30 is executed (hereinafter referred to as “target machine”). This processing is performed by simply assuming that any logically vectorizable loop can be treated as a vectorizable loop.

The vector operation expansion unit 13 performs processing such as expansion of a SIMD-incapable portion (a computation portion with no corresponding SIMD instruction), unrolling expansion, or selection of the optimum vector length on the intermediate program after vectorization performed by the vectorization unit 12. The instruction scheduling unit 14 optimizes the intermediate program processed by the vector operation expansion unit 13. The code generation unit 15 analyses the intermediate program optimized by the instruction scheduling unit 14 and forms object program 30.

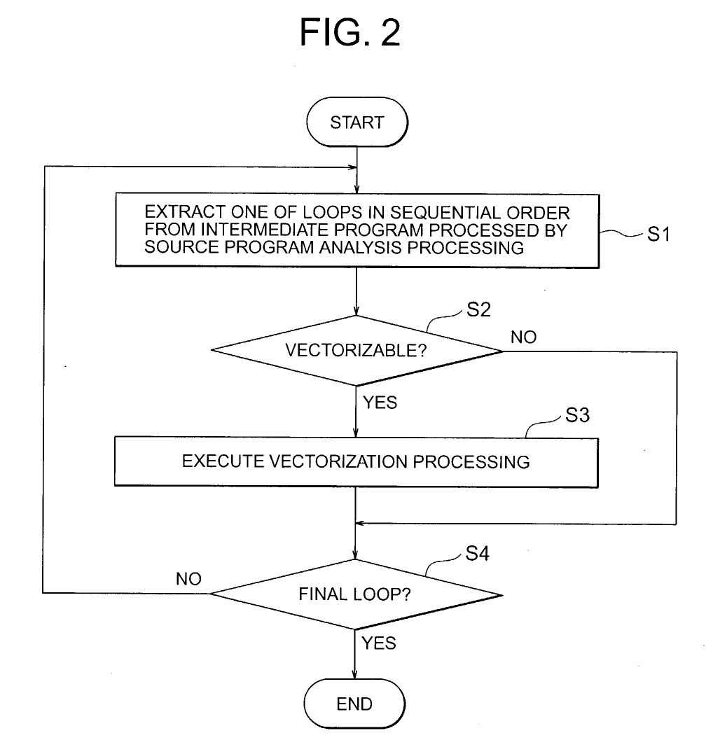

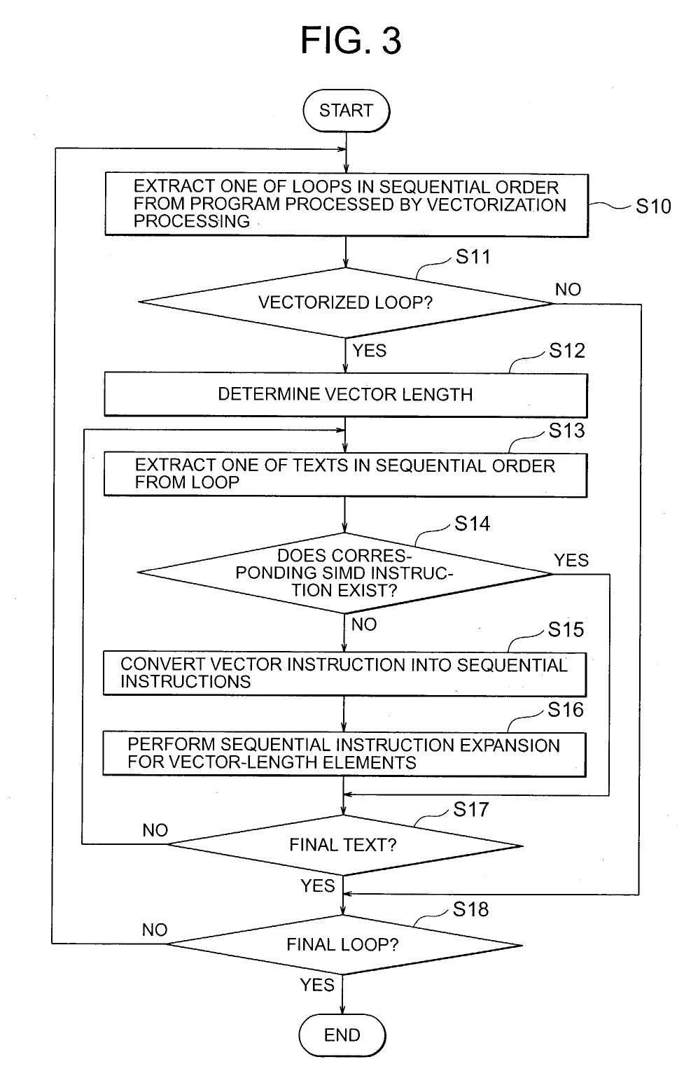

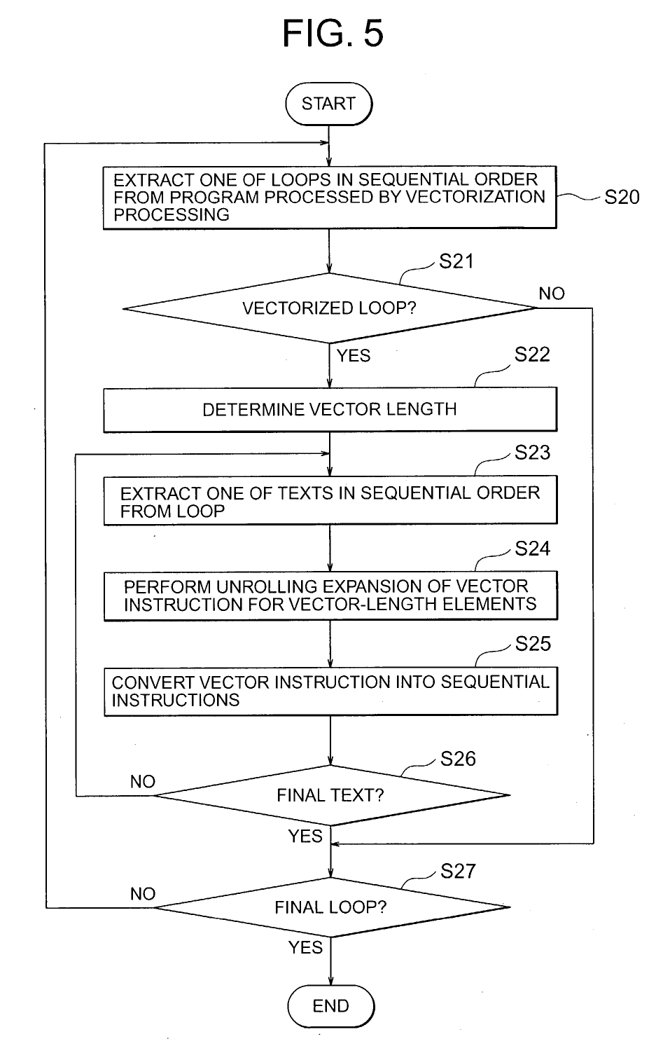

Description will now be made mainly of processing performed by the vectorization unit 12 and the vector operation expansion unit 13 particularly related to the present invention in Embodiment 1 in which the target machine on which the object program 30 is executed has a SIMD mechanism and Embodiment 2 in which the target machine has no SIMD mechanism. The vectorization unit 12 performs processing in the same manner in Embodiments 1 and 2 as described below with reference to FIG. 2. The vector operation expansion unit 13 performs processing as shown in FIG. 3 in the case of Embodiment 1, and performs processing as shown in FIG. 5 in the case of Embodiment 2.

<Embodiment 1>

Embodiment 1 is an example of a case in which the object program 30 target machine has a SIMD mechanism. However, it is not necessarily required that the target machine has a SIMD mechanism with respect to all arithmetical instructions.

In Embodiment 1, the vectorization unit 12 assumes that a portion which cannot be expressed by a SIMD instruction is pseudo-vectorizable, and vectorizes the portion. This vectorized portion is locally replaced with sequential arithmetical instructions by the vector operation expansion unit 13. Therefore, SIMD instructions and scalar instructions can be executed in parallel with each other to reduce the overhead.

FIG. 2 is a flowchart showing vectorization processing in Embodiment 1. The vectorization unit 12 extracts one of loops in sequential order from the intermediate program received from the source program analysis unit 11 (step S1) and determines whether the extracted loop is vectorizable (step S2). If it is determined that the loop is nonvectorizable, the process proceeds to processing in step S4. In the processing in step S2, determination is made only as to whether the loop is logically vectorizable regardless of whether the loop contains a computation with no corresponding SIMD instruction. For example, the loop is determined as nonvectorizable if an instruction exists which requires a computation incapable of parallel processing due to a definition of the value of a variable or a reference dependence relationship.

If it is determined by processing in step S2 that the loop is vectorizable, vectorization processing is performed on the loop (step S3). Determination is then made as to whether the extracted loop is the final one in the intermediate program (step S4). If the extracted loop is not the final one, the process returns to processing in step S1. If the extracted loop is the final one, the process ends.

FIG. 3 is a flowchart showing vector expansion processing in Embodiment 1. The vector operation expansion unit 13 extracts one of the loops in sequential order from the program vectorized by the vectorization unit 12 (step S10) and determines whether the extracted loop is one vectorized by the vectorization unit 12 (step S11). If the extracted loop is not a vectorized loop, the process proceeds to processing in step S18.

If it is determined by processing in step S11 that the extracted loop is a vectorized loop, the vector length corresponding to the SIMD instruction is selected and determined (step S12) and one of texts in sequential order is extracted from the extracted loop (step S13). Determination is then made as to whether the SIMD instruction corresponding to the extracted text exists in the target machine (step S14). If the corresponding instruction exists, the process proceeds to processing in step S17.

If it is determined by processing in step S14 that the corresponding instruction does not exist, the vector instruction of the extracted text is converted into sequential instructions (step S15) and sequential instruction expansion corresponding to the vector-length elements determined by processing in step S12 is performed (step S16). Processing in step S15 is such that the vector instruction VLOAD is converted into sequential instructions LOAD, for example. Processing in step S16 is such that if the vector length is determined as 2 for example, sequential instructions such as LOAD of the first element and LOAD of the second element corresponding to the vector-length elements are formed.

Determination is made as to whether the extracted text is the final one in the extracted loop (step S17). If the extracted text is not the final one, the process returns to processing in step S13. If it is determined by processing in step S17 that the extracted text is the final one, determination is made as to whether the extracted loop is the final one in the program (step S18). If the extracted loop is not the final one, the process returns to processing in step S10 to repeat the same processings. If the extracted loop is the final one, the process ends.

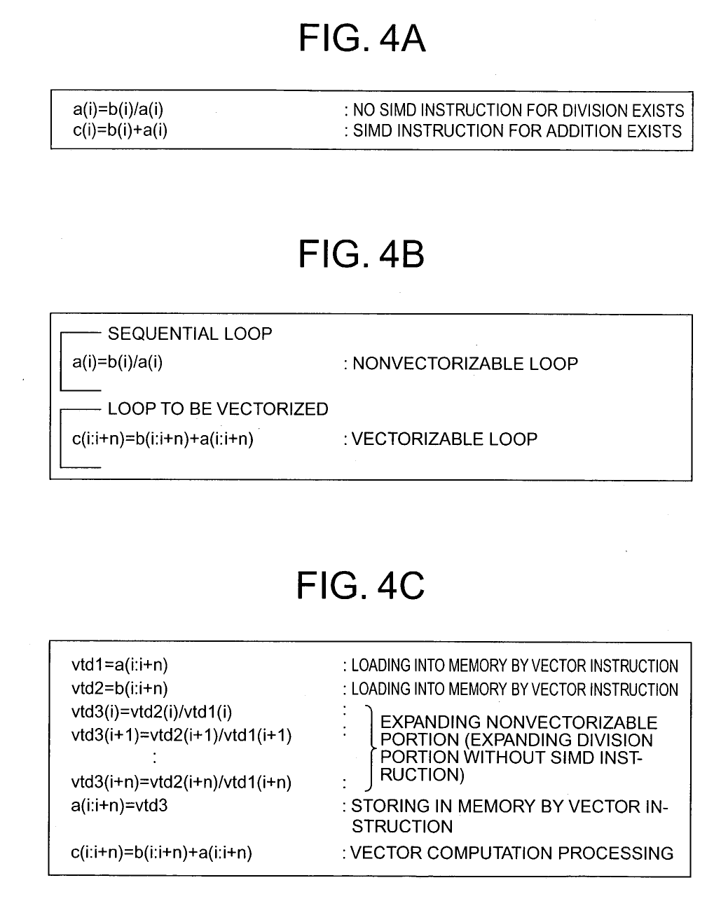

FIGS. 4A, 4B, and 4C are diagrams for explaining, by comparison, the difference between the conventional partial vectorization and the vectorization in Embodiment 1. In computation of the sequence shown in FIG. 4A, the computation of a(i)=b(i)/a(i) is a portion which cannot be expressed by a SIMD instruction since the target machine has no division SIMD instruction, while the computation of c(i)=b(i)+a(i) is a portion which can be expressed by a SIMD instruction.

FIG. 4B shows an example of partial vectorization performed by the conventional method on the computation shown in FIG. 4A In the conventional method, a computation is divided into vectorizable portions (portions which can be expressed by SIMD instructions) and nonvectorizable portions (portions which cannot be expressed by SIMD instructions). In the example shown in FIG. 4B, the nonvectorizable division portion is processed by a sequential loop, while the vectorizable portion is separately processed by a vectorization loop.

FIG. 4C shows an intermediate language image of an example of vectorization of the computation shown in FIG. 4A, which is based on the method in Embodiment 1, and in which the vector length is set to n+1. In FIG. 4C, “vtd” represents a vector temporary area (a register or an area in which data corresponding to the element length is temporarily held).

In the method in Embodiment 1, only the nonvectorizable division portion, in particular, in the sequential computation portion a(i)=b(i)/a(i) shown in FIG. 4A, which cannot be expressed by a SIMD instruction, is expanded into sequential instructions, while the vectorizable portion, e.g., memory load or memory store is executed by a vector instruction (SIMD instruction). Also, a sequential instruction expanded portion can also be formed in one vectorized loop by being combined with a vector instruction portion for expansion corresponding to the vector length. In the example shown in FIG. 4C, the vector length is n+1 and, correspondingly, the sequential instruction expanded portion is expanded n+1-parallel.

Thus, the method in Embodiment 1 combines two operations: a division and an addition in one loop unlike the conventional partial vectorization to reduce the overhead.

<Embodiment 2>

Embodiment 2 is an embodiment in a case where the target machine has no SIMD mechanism. No consideration is given to vectorization with respect to the conventional compiler in a case where the target machine has no SIMD mechanism. In contrast, in Embodiment 2, all logically vectorizable portions are pseudo-vectorized by the vectorization unit 12 and the vectorized portions are expanded into sequential arithmetical instructions by the vector operation expansion unit 13.

That is, Embodiment 2, on hardware having no SIMD mechanism, expansion into a sequential computation is made by using an arithmetical unrolling technique in such a manner that one vector operation is locally expanded with respect to a loop pseudo-vectorized. A sequence of instructions is thereby formed with which concealment of operational latency of the loop is realized. Optimization considering concealment of operational latency can also be performed by the subsequent instruction scheduling unit 14. According to Embodiment 2, however, concealment of operational latency of a loop can be performed with efficiency.

Concealment of operational latency of a loop is as described below. If memory access instructions and operations using their operands, or operations and other operations requiring direct reference to the results of the former operations occur successively, a delay in completion of the operations results. In such a situation, the dependence of instructions one on another is reduced by spacing apart the instructions (interposing an independent instruction therebetween) to improve the execution performance without causing a wait.

Processing by the vectorization unit 12 in Embodiment 2 is the same as that in Embodiment 1. Processing by the vector operation expansion unit 13 in Embodiment 2 is different from that in Embodiment 1.

FIG. 5 is a flowchart showing vector operation expansion processing in Embodiment 2. The vector operation expansion unit 13 extracts one of the loops in sequential order from a program vectorized by the vectorization unit 12 (step S20) and determines whether the extracted loop is one vectorized by the vectorization unit 12 (step S21). If the extracted loop is not a vectorized loop, the process proceeds to processing in step S27.

If it is determined by processing in step S21 that the extracted loop is a vectorized loop, the vector length corresponding to the SIMD instruction is selected and determined (step S22) and one of texts in sequential order is extracted from the extracted loop (step S23). The vector instruction of the extracted text is unroll-expanded in correspondence with the vector-length elements determined by processing step S22 (step S24) to be converted into sequential instructions (step S25). Processing in step S24 is such that if the vector length is determined as 2 for example, the vector instruction is expanded into sequential instructions such as VLOAD of the first element and VLOAD of the second element corresponding to the vector-length elements. Processing in step S25 is such that a vector instruction VLOAD, for example, is converted into sequential instructions LOAD.

Determination is made as to whether the extracted text is the final one in the extracted loop (step S26). If the extracted text is not the final one, the process returns to processing in step S23. If it is determined by processing in step S26 that the extracted text is the final one, determination is made as to whether the extracted loop is the final one in the program (step S27). If the extracted loop is not the final one, the process returns to processing in step S20. If the extracted loop is the final one, the process ends.

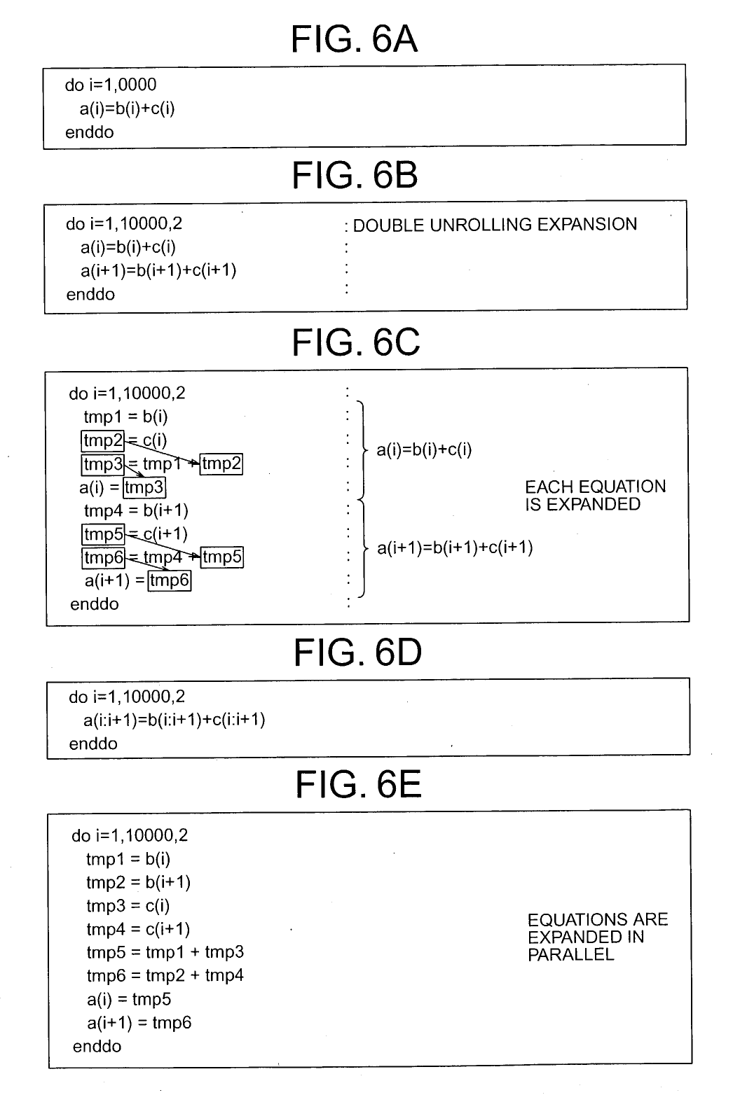

FIGS. 6A to 6E are diagrams for explaining, by comparison, the difference between conventional unrolling expansion and unrolling expansion in Embodiment 2. The conventional method and the method in Embodiment 2 will be compared with respect to a computation on a sequence shown as a program in FIG. 6A. In FIGS. 6A to 6E, “tmp” represents a temporary area (an area in which data is temporarily held).

FIG. 6B shows an example of double unrolling expansion performed by the conventional method on the computation shown in FIG. 6A. FIG. 6C shows an instruction expansion image of FIG. 6B. In the conventional unrolling expansion, memory access instructions and operations using their operands, or operations and another operations requiring direct reference to the results of the former operations occur successively, and a wait for each instruction is therefore caused at the time of execution of the instruction. In FIG. 6C, “tmp” in each rectangular frame represents a temporary area successively used.

FIG. 6D shows an example of vectorization of the computation in FIG. 6A performed by the method in Embodiment 2 setting a vector length of 2. FIG. 6E shows an instruction expansion image of FIG. 6D. In unrolling expansion in Embodiment 2, a computation is first pseudo-vectorized and unrolling expansion is collectively made on memory access instructions and operations using operands, so that the instructions having a dependence one on another are automatically separated. Consequently, the method in Embodiment 2, the dependence of instructions one on another is eliminated to prevent occurrence of a wait, thus enabling concealment of operational latency.

<Embodiment 3>

An embodiment in which, if a loop includes a condition statement such as an IF statement, vectorization of the loop is performed by determining a condition for enabling SIMD in the loop will be described as Embodiment 3. For example, if an IF statement exists in a loop, a portion controlled by the IF statement may be executed or not executed depending on the condition. Since a SIMD instruction is an instruction for processing a sequence of elements, it is impossible to vectorize a condition statement such as an IF statement in compilers for SIMD mechanisms in the conventional art.

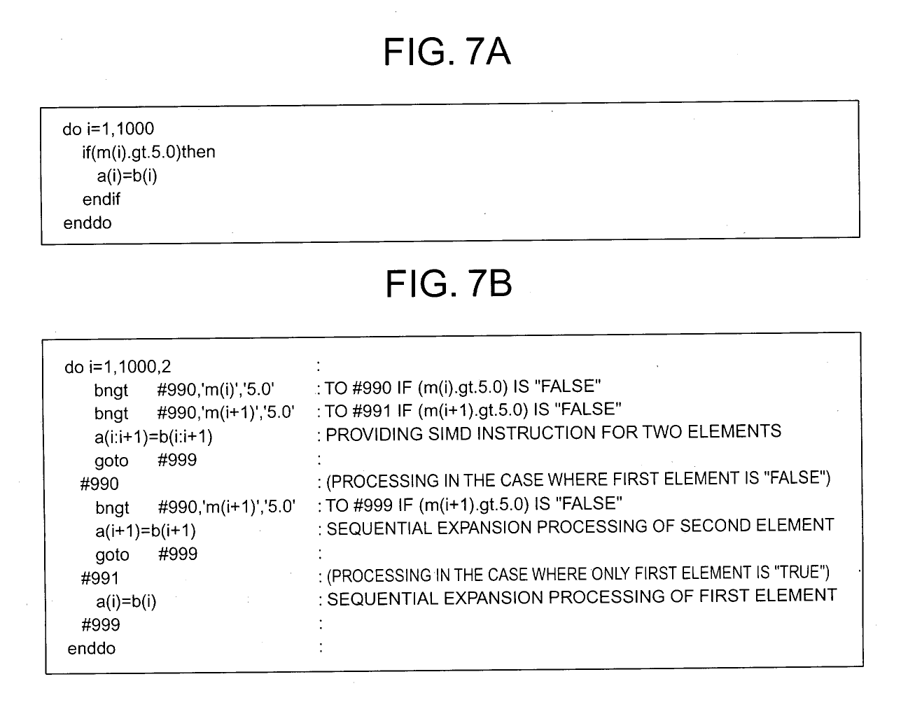

FIGS. 7A and 7B are diagrams for explaining vectorization in Embodiment 3. FIG. 7A shows an example of a loop of a program including an IF statement. FIG. 7B shows an expansion image of the result of processing of the program shown in FIG. 7A for consecutive two elements in a vector length of 2. Referring to FIG. 7B, only if both the consecutive two elements are “true”, a SIMD instruction can be provided for them.

Processing programmed as shown in FIG. 7B will be briefly described. A SIMD instruction is provided for the two elements if each of the first element and the second element is not “false” (is “true”). Sequential expansion processing on the first element is performed if the first element is “true” while the second element is “false”. Sequential expansion processing on the second element is performed if the first element is “false” while the second element is “true”. If each of the first element and the second element is “false”, processing is not performed on either of the two elements.

<Embodiment 4>

A case where a means for designating the vector length from outside will be described as Embodiment 4. In Embodiment 4, a user can designate a vector length. In general, if the vector length is longer, the paralleling efficiency is higher. However, if the vector length is increased, a problem, i.e., a possibility of deficiency of available register capacity, arises. In Embodiment 4, a user may designate a vector length considered optimum to improve the execution efficiency. For example, to enable vector length designation from outside, means for optional designation through a parameter at the time of startup of the compiler with respect to a source program and analysis means are provided. Alternatively, a statement (optimization control line) describable in a source program by a user for designation of a vector length with respect to the source program or a loop may be prepared.

Examples of the present invention will be described below with reference to the accompanying drawings.

### EXAMPLE 1

Example 1 is an example of processing in a case where a SIMD mechanism is provided but no SIMD expression can be given to part of a computation in a loop on the object hardware.

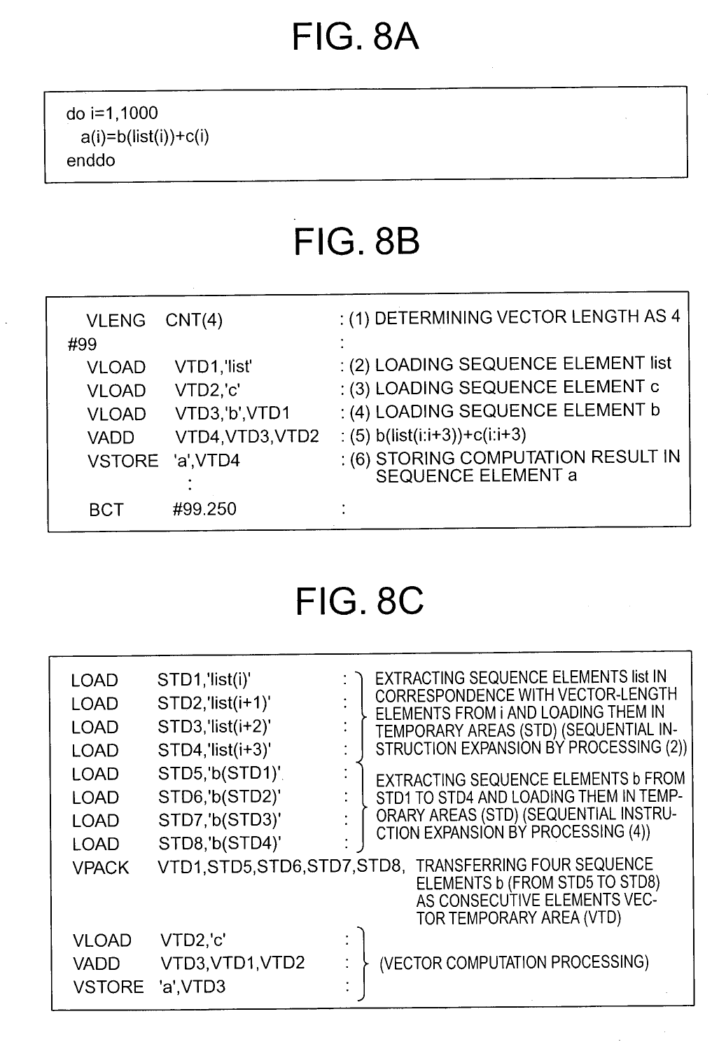

FIGS. 8A, 8B, and 8C show an example of an intermediate language image of vector operation expansion in Example 1. In FIGS. 8A, 8B and 8C, “STD” represents an ordinary temporary area and “VTD” represents a vector temporary area. FIG. 8A shows an example of a source program. The source program shown in FIG. 8A is analyzed by the source program analysis unit 11 and thereafter undergoes vectorization processing performed by the vectorization unit 12.

FIG. 8B shows an example of an intermediate program after analysis and vectorization processing on the source program shown in FIG. 8A. In the example of processing shown in FIG. 8B, the vector length is determined by the vectorization unit 12. By processing (1), the vector length is determined as 4. Thereafter, vector processing is performed with respect to four-element units. By processing (2), sequence element “list” is loaded into vector temporary area VTD1. By processing (3), sequence element “c” is loaded into vector temporary area VTD2. By processing (4), sequence element “b” is loaded into vector temporary area VTD3 according to the result of processing (2). By processing (5), addition of the four elements is performed as vector operation and the result of this addition is stored in vector temporary area VTD4. By processing (6), the value in the vector temporary area VTD4 obtained as a computation result is stored in sequence element “a”.

However, sequence element “b” in processing (4) is not a consecutive element but an element dependent on sequence element “list”. Therefore, no SIMD instruction for processing (4) exists, and the program in this state is not executable. Then, sequential instruction expansion of the nonvectorizable portion is performed by the vector operation expansion unit 13.

FIG. 8C shows an example of an intermediate program obtained by performing vector operation expansion processing on the intermediate program shown in FIG. 8B. With respect to processing (4) which cannot be expressed by a SIMD instruction, sequential instruction expansion of the vector-length elements (four elements in this example), involving processing (2) relating to processing (4), is performed by using the temporary areas (STD) and the results of this sequential computation are transferred to the vector temporary areas (VTD), thus performing vector operation processing.

### EXAMPLE 2

Example 2 is an example of pseudo-vectorization processing in a case where no SIMD mechanism is provided on the object hardware.

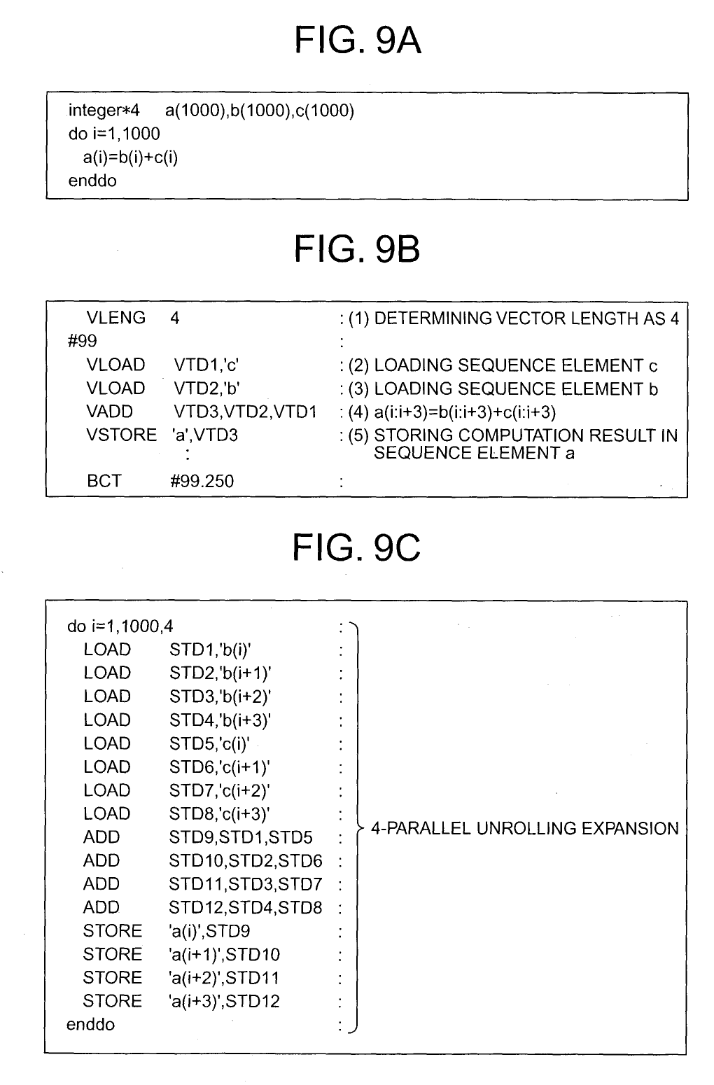

FIGS. 9A, 9B, and 9C show an example of an intermediate language image of vector operation expansion in Example 2. In FIGS. 9A, 9B, and 9C, “STD” represents an ordinary temporary area and “VTD” represents a vector temporary area. FIG. 9A shows an example of a source program. The source program shown in FIG. 9A is analyzed by the source program analysis unit 11 and thereafter undergoes vectorization processing performed by the vectorization unit 12.

FIG. 9B shows an example of an intermediate program after analysis and vectorization processing on the source program shown in FIG. 9A. In the example of processing shown in FIG. 9B, the vector length is determined by the vectorization unit 12. By processing (1), the vector length is determined as 4. Thereafter, vector processing is performed with respect to four-element units. By processing (2), sequence element “c” is loaded into vector temporary area VTD1. By processing (3), sequence element “b” is loaded into vector temporary area VTD2. By processing (4), addition is performed as four-element vector operation and the result of this addition is stored in vector temporary area VTD3. By processing (5), the value in the vector temporary area VTD3 obtained as a computation result is stored in sequence element “a”.

In the state shown in FIG. 9B, however, the program is only pseudo-vectorized and cannot be executed on hardware having no SIMD mechanism. Sequential instruction expansion is then performed by the vector operation expansion unit 13.

FIG. 9C shows an example of an intermediate program obtained by performing vector operation expansion processing on the intermediate program shown in FIG. 9B. Conversion into sequential instructions is made by performing unrolling expansion with respect to each vector instruction shown in FIG. 9B (4-parallel unrolling expansion because of the determined vector length 4). Since expansion is made on the basis of the sequence of instructions vectorized by the vectorization unit 12, the instructions are arranged so that the same temporary area (STD) is not used continuously.

### EXAMPLE 3

Example 3 is an example of processing in a case where a loop includes an IF statement and where mask processing is executed as vectorization processing. In this example, the target machine is assumed to be not equipped with a SIMD mechanism. The same processing is performed in the case of a target machine equipped with a SIMD mechanism, except for the portion processed by vector operation expansion processing.

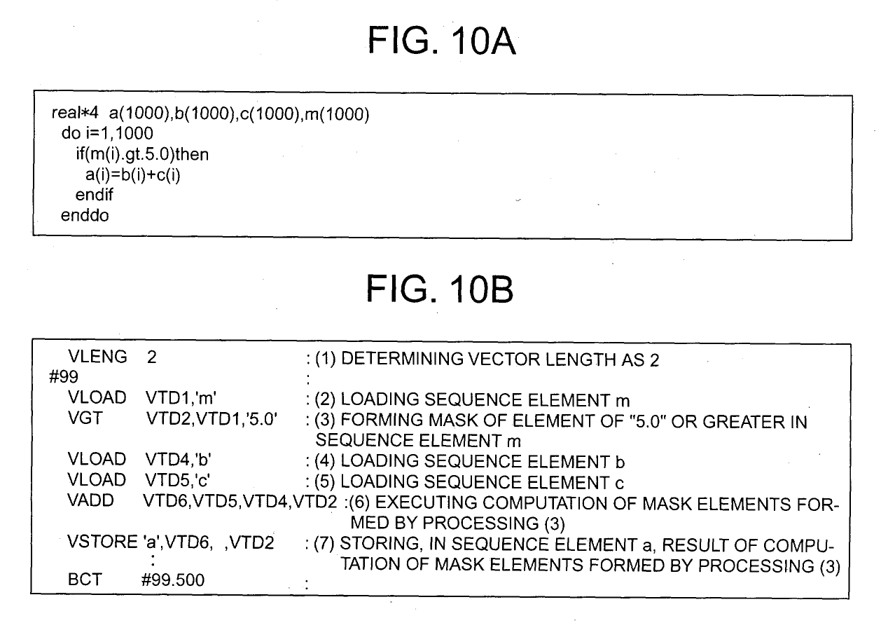

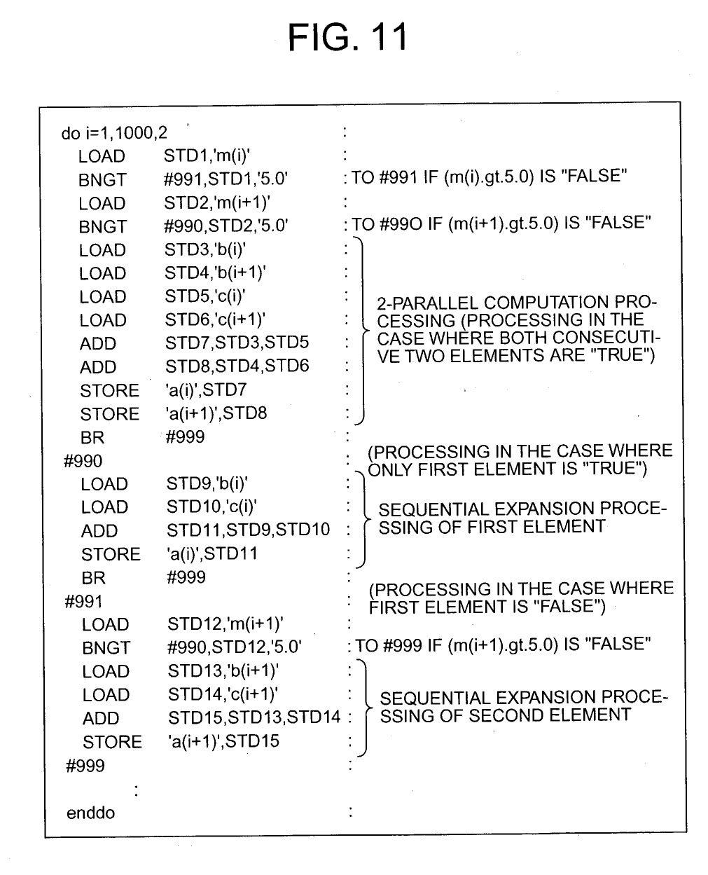

FIGS. 10A, 10B and 11 show an example of an intermediate language image after vectorization processing and an intermediate language image of vector operation expansion. In FIGS. 10A, 10B and 11, “STD” represents an ordinary temporary area and “VTD” represents a vector temporary area. FIG. 10A shows an example of a source program. The source program shown in FIG. 10A is analyzed by the source program analysis unit 11 and thereafter undergoes vectorization processing performed by the vectorization unit 12.

FIG. 10B shows an example of an intermediate program after analysis and vectorization processing on the source program shown in FIG. OA. In the example of processing shown in FIG. 10B, the vector length is determined by the vectorization unit 12. By processing (1), the vector length is determined as 2. Thereafter, vector processing is performed with respect to two-element units. By processing (2), sequence element “m” is loaded into vector temporary area VTD1. By processing (3), a mask of an element of “5.0” or greater in sequence element “m” loaded by processing (2) is formed in vector temporary area VTD2. By processing (4), sequence element “b” is loaded into vector temporary area VTD4. By processing (5), sequence element “c” is loaded into vector temporary area VTD5. By processing (6), addition of VTD4 and VTD5 corresponding to the mask element in VTD2 formed by processing (3) is performed and the result of this addition is stored in vector temporary area VTD6. By processing (7), the result of operation on the mask element formed by processing (3) is stored in sequence element “a”.

As described above, the description in FIG. 10B is such that a mask of a sequence m element of “5.0” or greater is formed by processing (3) and processing on the mask element only is performed as processings (6) and (7). However, as long as the vector processing is as described in FIG. 10B, the program cannot be executed. Sequential instruction expansion is then performed by the vector operation expansion unit 13.

FIG. 11 shows an example of an intermediate program obtained by performing vector operation expansion processing on the intermediate program shown in FIG. 10B. Referring to FIG. 11, expansion is made with respect to the combination of two consecutive elements “true” and “false” in sequence m since the vector length is determined as 2 by processing (1) in FIG. 10B. Computation processing is executed successively on the two elements only if each of the consecutive two elements is “true”. If the one element alone is “true”, computation processing is executed on only the element “true”. Computation processing is not executed if each of the consecutive two elements is “false”.

### EXAMPLE 4

Example 4 is an example of processing in a case where means for designating a vector length from outside of the target machine (from a user) is provided.

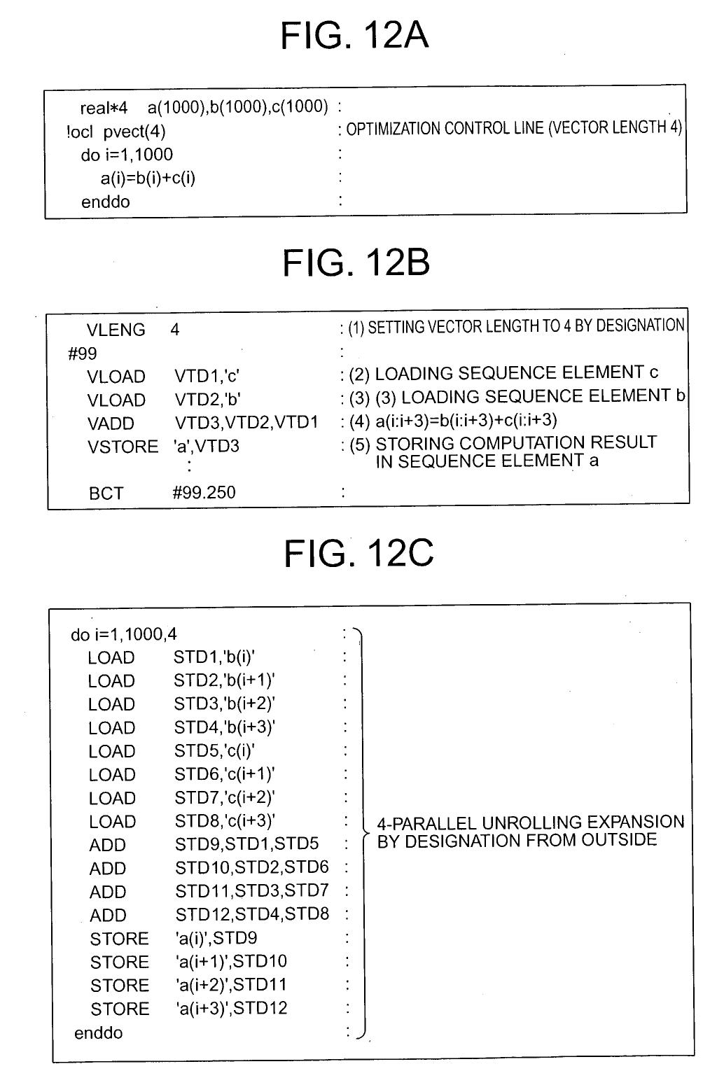

FIGS. 12A, 12B, and 12C are diagrams showing an example of intermediate language images in Example 4. In FIGS. 12A, 12B, and 12C, “STD” represents an ordinary temporary area and “VTD” represents a vector temporary area. FIG. 12A shows an example of a source program. As shown in FIG. 12A, a statement (optimization control line) for designating a vector length from outside (vector length 4 in the example shown in FIG. 12) is described in the source program. The source program shown in FIG. 12A is analyzed by the source program analysis unit 11 and thereafter undergoes vectorization processing performed by the vectorization unit 12.

FIG. 12B shows an example of an intermediate program after analysis and vectorization processing on the source program shown in FIG. 12A. By processing (1), the vector length is determined as 4 according to the designation in FIG. 12A. Thereafter, vector processing is performed with respect to four-element units. By processing (2), sequence element “c” is loaded into vector temporary area VTD1. By processing (3), sequence element “b” is loaded into vector temporary area VTD2. By processing (4), a four-element vector computation is performed. By processing (5), the result of this computation is stored in sequence element “a”.

In the state shown in FIG. 12B, however, the program is only pseudo-vectorized and cannot be executed, for example, on hardware having no SIMD mechanism. Sequential instruction expansion is then performed by the vector operation expansion unit 13.

FIG. 12C shows an example of an intermediate program obtained by performing vector operation expansion processing on the intermediate program shown in FIG. 12B. Conversion into sequential instructions is made by performing unrolling expansion with respect to each vector instruction shown in FIG. 12B (4-parallel unrolling expansion because of the determined vector length 4). Since expansion is made on the basis of the sequence of instructions vectorized by the vectorization unit 12, the instructions are arranged so that the same temporary area (STD) is not used continuously.

According to the present invention, as described above, a pseudo-vector operation expression is used with respect to a loop having no SIMD function or incapable of SIMD expression to treat the loop as a vectorizable loop, and a text in the loop is instruction-expanded according to the existence/nonexistence of a SIMD instruction, thus enabling generation of an object program having improved execution performance.

Also, vectorization processing is devised to enable a compiler in a case where the target machine has a SIMD mechanism and a compiler in a case where the target machine has no SIMD mechanism to have increased units capable of common processing, thus making it possible to shorten the compiler development process and facilitate development of compilers adapted to various target machines.

What is claimed is:

1. A compiler program for compiling a program executed on a computer equipped with a SIMD mechanism, wherein the compiler program causes the computer executing:
inputting and analyzing a source program;
providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program;
expanding the computation portion of the vectorizable loop expressed by the pseudo-SIMD instruction expression by replacing the computation portion with sequential instructions in the loop; and
generating an object program on a basis of the result of the expanding.

2. A compiler program for compiling a program executed on a computer equipped with no SIMD mechanism, wherein the compiler program causes the computer executing:
inputting and analyzing a source program;
providing a pseudo-SIMD instruction expression for a computation in a loop of the source program to make the loop vectorizable with reference to the result of analysis of the source program by assuming that the computer has a SIMD mechanism;
expanding the computation portion of the vectorizable loop expressed by the pseudo-SIMD instruction expression by replacing the computation portion with sequential instructions in the loop; and
generating an object program on a basis of the result of the expanding.

3. A compiler program according to claim 2, wherein the compiler program further causes the computer executing:
outputting an instruction expression for mask processing, in a case that a processing object loop in the providing processing includes a computation determined to be executed or not to be executed according to determination of a condition, according to the result of the determination of the condition to make the processing object loop vectorizable.

4. A compiler program according to claim 2, wherein the vector length is determined by designation from outside of the computer in the providing or expanding.

5. A compiler program according to claim 1, wherein the compiler program further causes the computer executing:
outputting an instruction expression for mask processing, in a case that a processing object loop in the providing processing includes a computation determined to be executed or not to be executed according to determination of a condition, according to the result of the determination of the condition to make the processing object loop vectorizable.

6. A compiler program according to claim 1, wherein the vector length is determined by designation from outside of the computer in the providing or expanding.

7. A recording medium for recording a compiler program to compile a program executed on a computer equipped with a SIMD mechanism, wherein the recording medium records the compiler program to cause the computer executing:
inputting and analyzing a source program;
providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program;
expanding the computation portion of the vectorizable loop expressed by the pseudo-SIMD instruction expression by replacing the computation portion with sequential instructions in the loop; and
generating an object program on a basis of the result of the expanding.

8. A recording medium for recording a compiler program to compile a program executed on a computer equipped with no SIMD mechanism, wherein the recording medium records the compiler program to cause the computer executing:
inputting and analyzing a source program;
providing a pseudo-SIMD instruction expression for a computation in a loop of the source program to make the loop vectorizable with reference to the result of analysis of the source program by assuming that the computer has a SIMD mechanism;
expanding the computation portion of the vectorizable loop expressed by the pseudo-SIMD instruction expression by replacing the computation portion with sequential instructions in the loop; and
generating an object program on a basis of the result of the expanding.

9. A compilation processing method for compiling a program executed on a computer equipped with a SIMD mechanism, the method comprising:
inputting and analyzing a source program;
providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program;
expanding the computation portion of the vectorizable loop expressed by the pseudo-SIMD instruction expression by replacing the computation portion with sequential instructions in the loop; and
generating an object program on a basis of the result of the expanding.

10. A compilation processing method for compiling a program executed on a computer equipped with no SIMD mechanism, the method comprising:
inputting and analyzing a source program;
providing a pseudo-SIMD instruction expression for a computation in a loop of the source program to make the loop vectorizable with reference to the result of analysis of the source program by assuming that the computer has a SIMD mechanism;
expanding the computation portion of the vectorizable loop expressed by the pseudo-SIMD instruction expression by replacing the computation portion with sequential instructions in the loop; and
generating an object program on a basis of the result of the expanding.

11. A compilation processing apparatus for compiling a program executed on a computer equipped with a SIMD mechanism, the apparatus comprising:
means for inputting and analyzing a source program;
means for providing a pseudo-SIMD instruction expression for a portion of a loop of the source program to make the loop vectorizable, in a case that a computation in the portion of the loop cannot be expressed as a SIMD instruction on the computer, with reference to the result of analysis of the source program;
means for expanding the computation portion of the vectorizable loop expressed by the pseudo-SIMD instruction expression by replacing the computation portion with sequential instructions in the loop; and
means for generating an object program on a basis of the result of the expanding.

12. A compilation processing apparatus for compiling a program executed on a computer equipped with no SIMD mechanism, the apparatus comprising:
means for inputting and analyzing a source program;
means for providing a pseudo-SIMD instruction expression for a computation in a loop of the source program to make the loop vectorizable with reference to the result of analysis of the source program by assuming that the computer has a SIMD mechanism;
means for expanding the computation portion of the vectorizable loop expressed by the pseudo-SIMD instruction expression by replacing the computation portion with sequential instructions in the loop; and
means for generating an object program on a basis of the result of the expanding.
